(19) United States
(12) Patent Application Publication
(10) Pub. No.: US 2005/0069840 A1
(43) Pub. Date: Mar. 31, 2005

(54) Customizable Interactive Classroom Display

(76) Inventor: Russell Grammer, Cape Girardeau, MO (US)

Correspondence Address: Tadeusz T. Dudek, 1404 Troy Lane, Round Rock, TX, 78664, US

(21) Appl. No.: 10/605,396

(22) Filed: Sep. 27, 2003

(51) Int. Cl. G09B 25/00

(52) U.S. Cl. 434/73

(57) ABSTRACT

A customizable interactive classroom display made from a flexible, easy to clean fabric on which ferromagnetic material strips are affixed. Transparent display elements are removably attached to the display by magnetic means. The elements have hollow cavities capable of receiving various media, such as cards, paper, photographs, newspaper and magazine clippings, and computer printouts. Further, the elements protect such media from wear and tear during use. Additionally, the elements can be tinted various colors and can also vary in size and shape. The elements can also be stacked on top of one another by virtue of the uniform placement of the magnetic means on each element.

### BACKGROUND OF INVENTION

1. Field of the Invention

The present invention relates generally to educational displays and specifically to a fabric display with easily removable transparent display elements capable of retaining, displaying and protecting various media of the user's choosing for a number of educational processes.

2. Description of the Prior Art

There are numerous educational displays available to the educator, such as chalk boards, white boards, and maps. Chalk boards and white boards are adequate for conveying educational concepts employing the use of letters, numbers, or other relatively simple symbols. However, complex symbols and figures quickly become more difficult, if not impossible, to accurately represent on these displays as such tasks relate directly to the artistic ability of the user. Moreover, maps, while capable of displaying highly detailed information, cannot be interacted with or customized.

One teaching aid teaches the use of a fabric chart with indicia on at least one surface of the chart and a plurality of removable relational manipulative elements. However, the relational elements are designed to relate to one another as well as the indicia on the chart and are not customizable by the end user. Moreover, the attachment means taught, namely hook-and-loop and low-tack adhesive means tend to degrade in adhesive strength when subjected to the proposed constant repetitive use by school-aged children.

Another teaching aid teaches the use of a chart with a plurality of clear pockets for holding and displaying relational media. However, media placement on the chart necessarily requires the users to handle the media directly, thus the media is not protected from wear and tear associated with interaction with the chart. Also, placement of media is restricted to the location and number of pockets available.

Yet another teaching aid teaches the use of a magnetic bulletin board on which magnetic elements such as numbers or letters can be placed. However, like the fabric chart above, the magnetic boards elements are designed to relate to one another and are not customizable by the end user. Moreover, the bulletin board cannot be folded and stored when not in use or easily transported.

Thus, there remains a need for a new and improved interactive user customizable classroom display capable of being folded and stored when not in use and for ease of transport between classes which includes a durable means for removably attaching the display elements to the display as well as a means for providing protection for various display media of the user's choosing.

### SUMMARY OF INVENTION

The present invention relates to an interactive customizable classroom display consisting of a fabric panel with ferromagnetic material strips affixed to the back of the panel and a plurality of transparent display elements capable of being attached to the panel by magnetic means. Furthermore, these display elements have cavities and a means for receiving and displaying such media as may be desired by the educator. The term “media” is generally defined as substantially flat, usually paper-based articles such as papers, cards, photographs, magazines, newspapers, computer print-outs, and the like.

The display can be used for a number of purposes in the classroom, including, but not limited to, an attendance chart, a word association chart, an interactive visual display, as well as others, as required by the educator, simply by inserting the appropriate media into the display elements and arranging the display elements onto the chart.

### BRIEF DESCRIPTION OF DRAWINGS

FIG. 1 is a front view of a customizable interactive class-room display embodiment of the present invention;

FIG. 2 is a view of a customizable interactive classroom display embodiment with a cutout which partially reveals one of the ferromagnetic material strips employed in the display;

FIG. 3 is a top view of a customizable interactive classroom display illustrating how the display panel can be folded for storage or transport when not in use; and

FIG. 4 is a top view of a manipulative transparent element illustrating a means for receiving and retaining media within the cavity of the element as well as a magnetic means for removably attaching the element to the display panel.

### DETAILED DESCRIPTION

With reference to the accompanying drawings, an embodiment of the customizable interactive classroom display is illustrated generally in 10. The main components of the display include the fabric display panel, 11, and a number of transparent display elements, 12.

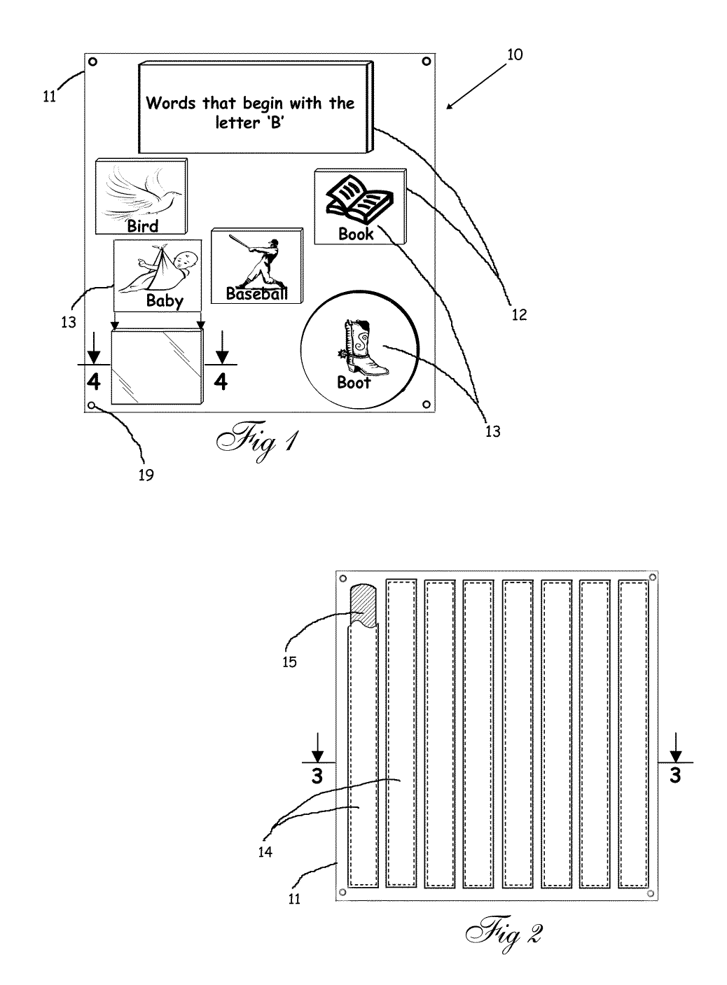

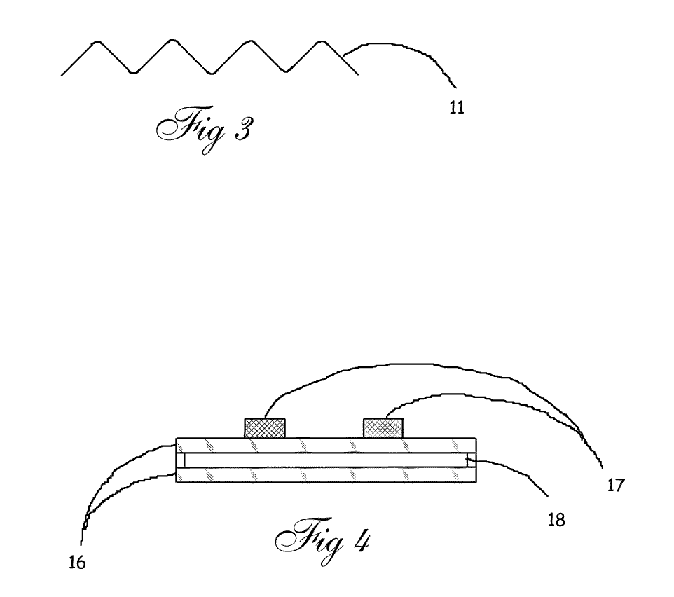

In a preferred embodiment of the present invention, the display panel is made of nylon or other durable, thin, lightweight, fabric which is flexible and easy to clean. Ferromagnetic strips are affixed to the display panel. These strips can be affixed a number of ways, such as being retained by fabric strips, 14, sewn over the ferromagnetic strips, 15, as illustrated in FIG. 2. Adequate space should be maintained between the ferromagnetic strips to allow the folding of the display panel when not in use. The actual space required between each strip will vary with the materials used in the panel as well as the ferromagnetic strips. Although the illustration depicts the ferromagnetic strips affixed in a vertical fashion on the display panel, this is but one embodiment. One skilled in the art can readily comprehend that the ferromagnetic strips can be positioned at an angle or horizontally as well, so long as the strips remain parallel to one another so as to permit the panel to be folded for easy storage or transport, as illustrated in FIG. 3. Ideally, the ferromagnetic strips should be a lightweight, flexible, stainless steel, capable of strongly attracting a magnet, such as the type commonly known as “band” steel, which is used primarily for strapping freight to pallets. Means for mounting the display panel onto a wall, such as grommets place along the edges of the panel, 19, are illustrated, although various other means, such as hooks, magnets, picture hangers, can readily be employed.

The transparent display element, 12, consists of two layers, 16, of a transparent material that are placed one atop the other in such a manner as to create a cavity between the two layers. In a preferred embodiment of the present invention, the transparent material is transparent vinyl or other durable, shatterproof, lightweight material. The layers are sealed together along all edges, but at least one edge, 18, is left open, exposing the cavity and thus providing a means for inserting and removing media, 13, into and out of the cavity. Magnetic means, such as permanent magnets, 17, are affixed to the back of the display element so that the number, placement and polarity of the magnets are kept uniform with respect to all other display elements, thus enabling the display element to be removably attached to any other display element.

The media can be virtually anything of the user's choosing, so long as it is capable of fitting through the opening, 18. Typical examples of such media include photographs, paper, cards, clippings of newspapers and magazines, computer print-outs, etc.

Those skilled in the art can readily appreciate the numerous applications to which the current invention would lend itself. For example, with the advent of digital photography and image editing software, an educator using a personal computer, could edit a digital image of each student in the class, adding personal information, such as name, favorite food, etc., scale the picture to fit within the display element and then print out each picture. Once trimmed and inserted into the display elements, the pictures could be arranged on the display to coincide with a seating assignment. The composite would provide a visual aid from which one could learn about everyone else in the class.

In yet another application, the display can be used to track attendance. For example, a row of subheadings consisting of display elements with index cards of the names of the various activities in which students participate throughout the day is followed by columns of display elements with index cards of the names of the students in the class. These elements are positioned under the appropriate sub-heading whenever a student engages in that activity.

Another application of the current invention includes a teaching aid for teaching sentence structure. If the transparent display elements are tinted various colors, this would enhance the teaching process. For example, all subjects could be placed in the blue tinted elements, all action words in the yellow tinted elements, and all objects in the green tinted elements. In this way, various sentences can be constructed by switching one element for another. Additionally, because the magnetic means of each display element is aligned in both polarity and position with every other display element, the display elements can be stacked on top of one another on the display, further enhancing the activity.

With the advent of erasable markers, instructors can also enhance the learning experience of any application by writing on the surfaces of the elements themselves, thereby preserving the integrity of the media so that the media can be reused in future applications while simultaneously emphasizing educational concepts.

Thus, the customizable interactive classroom display has been shown and described in various applications. Although specific applications of the present invention have been described, additional applications may become obvious to those skilled in the art. The present invention, therefore, should not be limited in any way, other than within the scope of the following claims.

1. A customizable interactive classroom display comprising:
a flexible fabric planar panel, said panel including:
a plurality of ferromagnetic material strips parallelly affixed to one side of said panel; and
a means for hanging said panel on a wall;
a plurality of substantially flat manipulative transparent elements, said elements including:
a magnetic means for removably attaching said transparent elements to said panel; a cavity within said transparent elements;
and a means for receiving and retaining media within said cavity so that the media is protected from wear and tear during use.

2. The interactive display according to claim 1, wherein said transparent elements are made from a lightweight, shatterproof material, such as clear flexible vinyl.

3. The interactive display according to claim 1, wherein said transparent elements are tinted various colors.

4. The interactive display according to claim 1, wherein said receiving and retaining means is at least one opening along an edge of said transparent element.

5. The interactive display according to claim 1, wherein said magnetic means for removably attaching said transparent elements to said panel is at least one permanent magnet uniformly affixed to each of said transparent elements such that the placement and polarity of the permanent magnets are identical with respect to all other said transparent elements to facilitate in removably attaching one transparent element on top of another transparent element.

6. The interactive display according to claim 1, wherein said hanging means is a plurality of members located along the edges of said panel, said members selected from a group consisting of grommets, hooks, and magnets.
